(19) United States
(12) Patent Application Publication
(10) Pub. No.: US 2004/0071379 A1
(43) Pub. Date: Apr. 15, 2004

(54) Rolling bearing with nitriding steel cylindrical rollers

(76) Inventor: Herve Carrerot, Vico (FR)

Correspondence Address: STURM & FIX LLP, 206 SIXTH AVENUE, SUITE 1213, DES MOINES, IA, 50309-4076, US

(21) Appl. No.: 10/655,172

(22) Filed: Sep. 4, 2003

Related U.S. Application Data
(63) Continuation of application No. PCT/FR02/00712, filed on Feb. 27, 2002.

(30) Foreign Application Priority Data
Mar. 6, 2001 (FR) FR 06/03/2001

(51) Int. Cl. F16C 33/34

(52) U.S. Cl. 384/565

(57) ABSTRACT

The invention concerns a rolling bearing with relieved cylindrical rolling elements maintained in a cage (4) between a cylindrical inner raceway on an inner steel ring (2) and a cylindrical outer raceway on an outer steel ring (1) and bordered by at least and annular lateral flange (11) projecting substantially radially inwards on the outer ring (1). Said rolling bearing is such that at least the rolling elements (3) are made of deep nitriding steel, comprising 0.3% of C. 3% of Cr. 1% of Mo. 0.25% of V, and 0.15% of Ni, prepared by double vacuum smelting and whereof at least the white nitride surface layer has been completely eliminated from at least all the working surfaces of the rolling elements (3) coming into contact with the rings (1, 2) and/or the cage (4). The invention is useful for mounting in rotation in particular stages of aircraft turbo-compressor rotors and turbojets.

The invention relates to a cylindrical roller bearing, of the “tapered” type, the steel rollers of which are held in a cage between a cylindrical inner raceway, defined on a smooth surface in an external radial position on a steel inner ring, and a cylindrical outer raceway, defined on a surface in an internal radial position of a steel outer ring and bordered by at least one annular lateral shoulder projecting substantially radially inward on the outer ring, which is coaxial with the inner ring, with the raceways facing each other and with said annular shoulder.

It is known that “tapered cylindrical rollers” means rollers with symmetry of revolution about an axis, and each of which has a cylindrical central part of circular cross section extended, in the axial direction and symmetrically on each side, by a slightly frustoconical end portion coaxial with the cylindrical central part and converging axially outward with a very small angle, each frustoconical portion being joined, via a rounded annular part, with a constant radius of curvature, to one of the two lateral, or axial end, faces of the roller, that are perpendicular to the axis of the roller, respectively.

It is known that the main advantage provided by the use of tapered cylindrical rollers in rolling bearings is to prevent excessive stresses generated, at the joins between their cylindrical central part and their very slightly frustoconical end portions, when the rollers tilt during operation of the rolling bearing.

The invention relates more specifically to a tapered cylindrical roller bearing, as presented above, of high precision, for example of ISO4-RBEC7 level, and in particular of aeronautical quality.

Already used in aeronautics, especially for the rotary mounting of aircraft turbojet compressor rotor stages, are tapered cylindrical roller bearings of the abovementioned type, the rollers of which are made of a steel chosen from conventional bearing steels, preferably of the M50 or 100C6 type, and the inner and outer rings of which are made of a steel chosen from the aforementioned conventional bearing steels, preferably of the M50 or 100C6 type, or from structural nitriding or case-hardening steels, preferably of, the 32CDV13 or M50NIL type, respectively.

In the aforementioned application, for the rotary mounting of turbojet compressor rotor stages, it has been found that the tapered cylindrical roller bearings of the prior art are very sensitive to and embrittled by the ingestion of foreign particles, having generated surface microcracks that progress until spalling of the rollers and raceways of the rings, hence an indentation of the contacting surfaces of the rollers and of the rings, when foreign particles are absorbed.

As a result, these rolling bearings have an excessively short lifetime, on account of the relatively rapid appearance of the first surface fatigue cracks that cause spalling of the tapered cylindrical rollers and of the raceways of the rings.

The problem at the basis of the invention is to produce a tapered cylindrical roller bearing, of the abovementioned known type, but better suited to the various practical requirements than the rolling bearings of this type that are currently used, and one object of the invention is to propose such a tapered cylindrical roller bearing that benefits from an extended lifetime, by pushing back the fatigue behavior limits of the contacting surfaces between the rollers and the rings, and therefore has a greater resistance to indentation of the contacting surfaces, during ingestion of foreign particles, as it very substantially delays the appearance of surface fatigue cracks that cause spalling of the rollers and of the raceways of the rolling bearing cages.

It is, therefore one object of the invention to propose a tapered cylindrical roller bearing of the aforementioned type and intended in particular to be used for the rotary mounting particularly of airplane turbojet compressor rotor stages.

These objects have been achieved, surprisingly and unexpectedly, by the tapered cylindrical roller bearing according to the invention, which is characterized in that at least the rollers are made of a deep-nitrided nitriding steel (i.e. a steel that has undergone a thermochemical deep nitriding treatment) comprising, in percent by weight, around:

0.3% C,

3% Cr,

1% Mo,

0.2% V,

0.15% Ni,

produced by double vacuum smelting, and the white surface layer of nitrides of which has been completely removed from at least all the working faces of the rollers that come into contact with the rings and/or the cage.

Advantageously, the depth of nitriding of the deep nitriding steel lies within a range extending from about 0.45 mm to about 0.75 mm.

Preferably, the deep-nitrided nitriding steel is a 32CDV13 steel and, in the embodiment that gave the best results, this 32CDV13 steel is of the G.K.H.Y.W. grade of the French steelmaker Aubert & Duval.

It has been found that the roller bearing according to the invention exhibits better fatigue behavior of the contacting surfaces between rollers and rings and therefore better resistance to indentation of the contacting surfaces during absorption of foreign particles, compared with the roller bearings of the same type of the prior art, so that the lifetime of the roller bearings according to the invention is greatly extended compared with that of the known similar rolling bearings, before the appearance of the first surface fatigue cracks that cause spalling of the rollers and of the raceways of the rings.

As regards the outer and inner rings, at least one of these may be made of a conventional bearing steel, of the 100C6 type, or else of the M50 (or 80DCV40) type comprising, in percent by weight, around:

0.8% C,

4% Cr,

4% Mo,

1% V,

0.15% Ni,

and produced by double vacuum smelting and with a through-hardening heat treatment.

As a variant, at least one of the outer and inner rings may be made of a structural case-hardening steel of the M50NIL type comprising, in percent by weight, around:

0.12% C,

4% Cr,

4% Mo,

1.2% V,

3.5% Ni,

and produced by double vacuum smelting and with a thermochemical case-hardening treatment.

However, the best performance is obtained when at least one of the outer and inner rings of the rolling bearing, and preferably each of the rings, is made of a nitriding steel similar or preferably identical to that of the rollers and deeply nitrided with complete removal of the white surface layer of nitrides over at least the entire surface of said ring that is intended to come into, contact with the rollers and/or the cage.

Advantageously, the nitriding is carried out so that the rollers and, where appropriate, the ring or rings made of deep nitriding steel have a surface Vickers hardness lying within a range extending from about 720 to about 850 under a load of 0.5 kg and a core Vickers hardness (beneath the nitrided layer) lying within a range extending from about 330 to about 420 under a load of 0.5 kg.

In a known manner, the cage may be a one-piece metal cage and have as many cells as the rolling bearing has rollers, each cell housing one of the rollers respectively, said cage being centered on the outer ring of the rolling bearing.

In this case, it is advantageous according to the invention for the metal cage to be made of bronze or of a vacuum-smelted 40NCD7-type steel, with surface silvering at least in the cells.

Also advantageously, the cylindrical outer raceway is defined on the outer ring between two annular lateral shoulders projecting substantially radially inward so that the rollers are held between the two lateral shoulders of the outer ring.

For this purpose, it is also advantageous for, on the one hand, the ratio of the radial height of each shoulder to the diameter of the rollers to lie within a range extending from about 0.29 to about 0.31 and, on the other hand, for each shoulder to have an internal face, turned toward the rollers, that has a small taper angle lying within a range extending from about 15′ to about 45′.

In addition, to allow the cage to be centered by the outer ring, each shoulder of the outer ring may have a cylindrical surface, in an internal radial position, coaxial with the outer raceway and forming a surface for centering the cage.

As regards the inner raceway, this is advantageously defined on the inner ring between two axial end portions of said inner ring, each having a frustoconical external face converging axially outward.

Other advantages and features of the invention will stem from the description given below, in a non-limiting manner, of an illustrative example described with reference to the appended drawings in which:

FIG. 1 is a view in side elevation of the tapered cylindrical roller bearing;

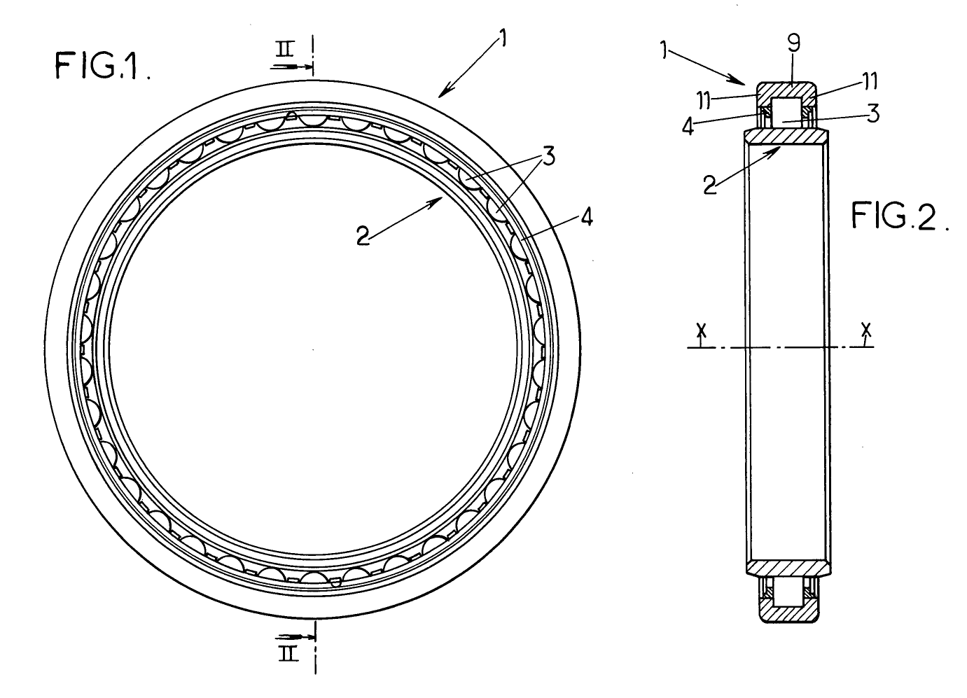

FIG. 2 is a sectional view of the rolling bearing of FIG. 1 in the diametral plane of section II-II of FIG. 1;

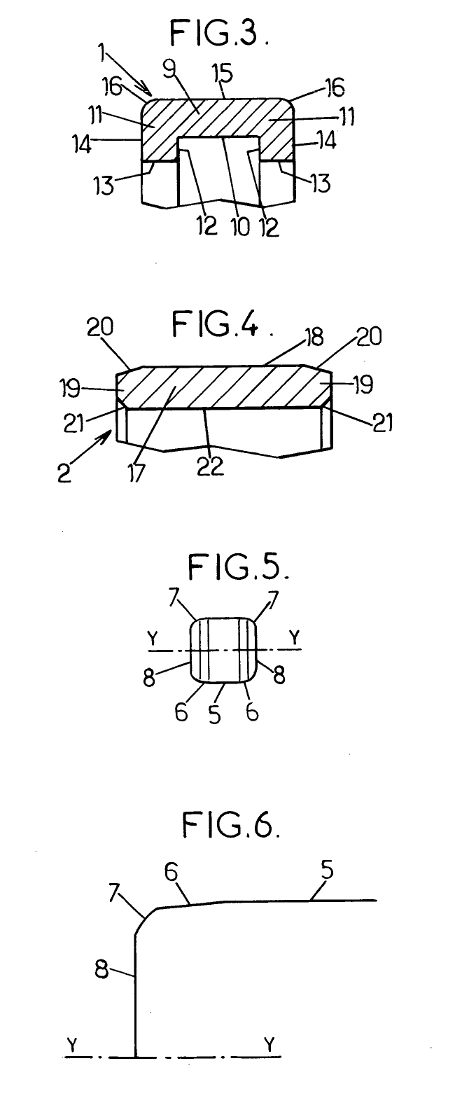

FIG. 3 is a cross-sectional view, on a larger scale, of the outer ring of the roller bearing of FIGS. 1 and 2;

FIG. 4 is a cross-sectional view, similar to FIG. 3, of the inner ring of the roller bearing of FIGS. 1 and 2;

FIG. 5 is a side view of a tapered cylindrical roller;

FIG. 6 is a partial schematic view on a larger scale of a detail of FIG. 5, specifying the geometry of the tapered cylindrical roller;

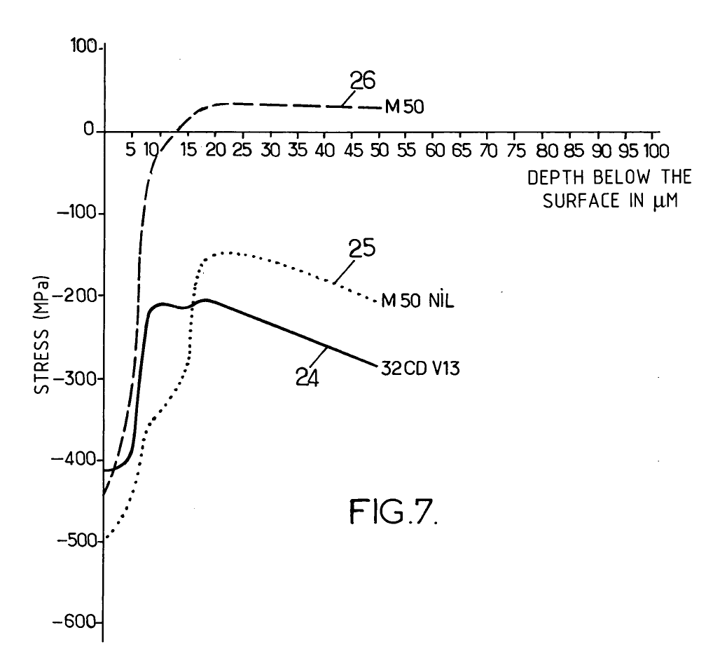

FIG. 7 shows profiles, near the surface, of residual stresses on finished machining components, such as rollers and rings of the rolling bearing, before the thermochemical deep nitriding treatment of the components made of 32CDV13, or the thermochemical case-hardening treatment of one or both rings made of M50NIL, or else before the through-hardening heat treatment of one or both rings made of M50;

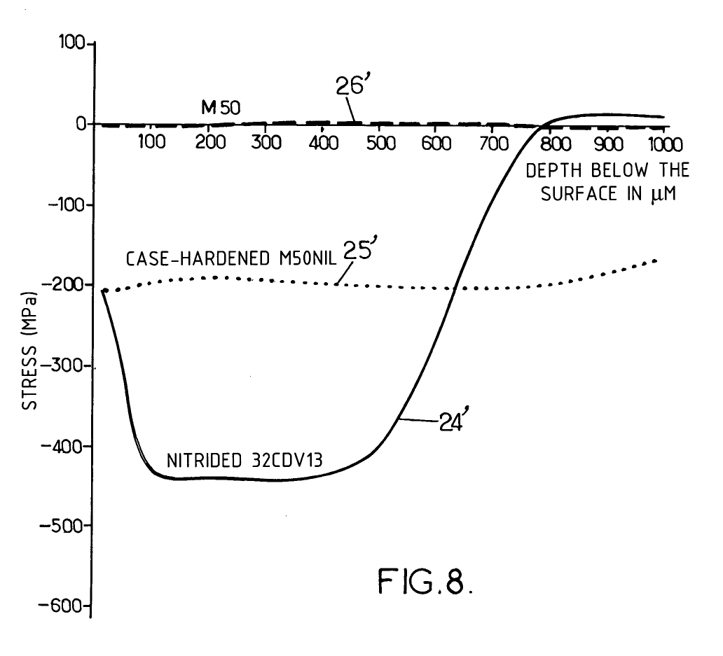

FIG. 8 shows profiles of residual stresses that are due to the corresponding thermochemical or heat treatment on these same components; and

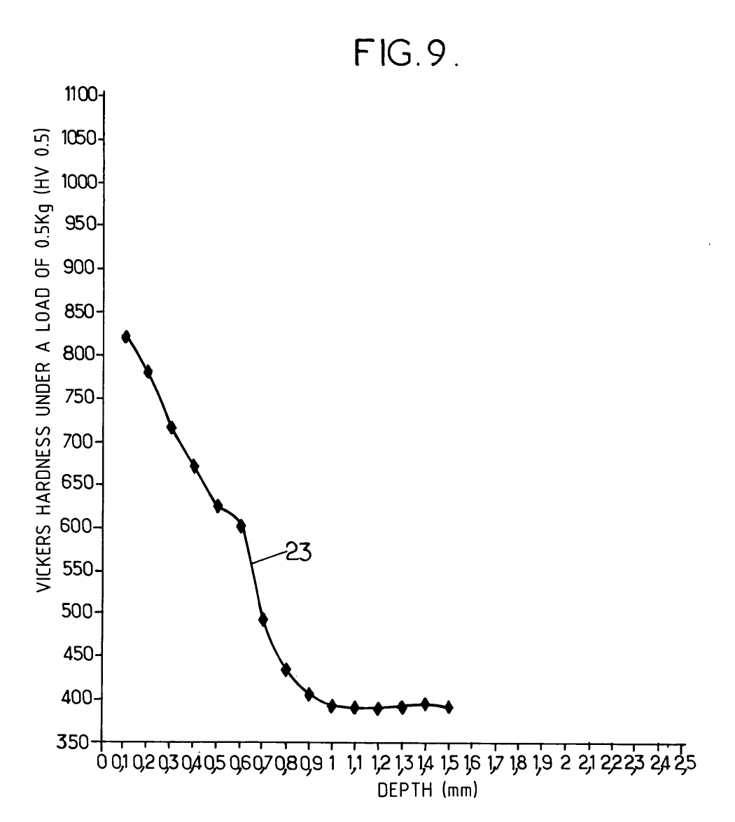

FIG. 9 shows the optimum hardness profile as a function of depth in a component (roller or ring) made of nitrided 32CDV13 steel within a deep-nitrided surface.

The roller bearing of FIGS. 1 to 6 essentially comprises an outer ring 1, an inner ring 2, rollers 3 placed between the rings 1 and 2, which are coaxial about the axis X-X of the rolling bearing, and an annular cage 4, that is also placed between the rings 1 and 2 and has as many cells, uniformly distributed over its periphery, as the rolling bearing has rollers 3, each cell of the cage 4 housing one of the rollers 3, respectively.

The cage 4 and each of the rings 1 and 2, as well as each of the rollers 3, is a one-piece metal element, and the steel rings 1 and 2 each have symmetry of revolution about the axis X-X of the rolling bearing and are each symmetrical with respect to the radial mid-plane of the rolling bearing, and likewise each roller 3, also made of steel, has symmetry of revolution about its own axis Y-Y and is symmetrical with respect to a plane perpendicular to this axis Y-Y, passing through its middle.

This roller bearing is of the type having tapered cylindrical rollers 3, that is to say each roller 3 has the shape shown in FIGS. 5 and 6: each roller 3 has a cylindrical central part 5 of circular cross section, that is extended axially on each side by one of two end parts 6 respectively, these parts being symmetrical with each other and hawing an external lateral surface that is very slightly frustoconical and converges axially outward, each frustoconical part 6 being joined, via an annular, convex and rounded part 7 of constant radius of curvature, to one of the two lateral faces 8 (or axial end faces) of the roller 3 respectively, each lateral face 8 extending perpendicular to the axis of revolution Y-Y of the roller 3, the two frustoconical parts 6 and the two convex parts 7 being coaxial with the cylindrical central part 5.

In this illustrative example, each of the thirty-four rollers 3 is such that the diameter of its central cylindrical part 5 is equal to the axial length of the roller 3, between the two lateral faces 8, so that the shape of each roller 3, seen in plan, is that of a square with rounded corners.

The annular cage 4 thus has thirty-four cells, each of which has a cross section corresponding approximately to the shape, in plan or in cross section by a diametral plane, of a roller 3, that is to say square with rounded corners.

The outer ring 1 has a U-shaped cross section (see FIGS. 2 and 3) with radially inward concavity (with respect to the axis X-X of the rolling bearing); this ring 1 comprises a cylindrical annular central part 9 of circular cross section, the surface of which in the internal radial position constitutes a cylindrical outer raceway or track 10, defined between two annular lateral shoulders 11 projecting radially inward on the sides of the central part 9. Each of the shoulders 11, that are mutually symmetrical with respect to the radial mid-plane of the outer ring 1, has, on the same side as the outer raceway 10, that is to say on the side turned toward the rollers 3, an inclined internal face 12 with a small taper angle lying within a range extending from about 15′ to about 45′, so that the two internal faces 12 move slightly further apart, in the inward radial direction, from the external raceway 10 as far as a cylindrical surface 13, in the internal radial position on the corresponding shoulder 11, this cylindrical surface 13 being coaxial with the outer raceway 10 and forming a surface for centering the cage 4.

Furthermore, the radial height of each shoulder 11, that is to say the distance, in the radial direction between the outer raceway 10 and the centering surfaces 13, that corresponds substantially to the height of the internal face 12 with a small taper angle, is such that the ratio of this radial height of each shoulder 11 to the diameter of the rollers 3 lies within a range, extending from about 0.25 to about 0.35, and preferably from about 0.29 to about 0.31.

The external lateral radial faces 14 of the shoulders 11 are each joined to the cylindrical face 15, in the external radial position, of the central part 9 of the outer ring 1 via a slightly convex bevel 16.

Thus, the metal cage 4, machined from a forged blank, for example made of bronze or of a vacuum-smelted 40NCD7-type steel (with in this case a Rockwell hardness of 23 to 35 HRc), and with surface silvering at least in the cells housing the rollers 3, is centered on the cylindrical faces 13 of the shoulders 11 of the outer ring 1 so that the cage 4 is coaxial with the outer ring 1 and with the outer raceway 10 about the axis X-X of the rolling bearing. The cage 4 is also such that its lateral radial faces do not extend to the outside, in the axial direction, of the external lateral radial faces 14 of the outer ring 1, and its cylindrical face, in the external radial position (that comes into contact with the faces 13 of the shoulders 11) is also covered with a silver coating by a surface treatment according to the United States specification AMS2410.

The inner ring 2 (see FIGS. 2 and 4) includes a cylindrical annular central, part 17 of circular cross section, the smooth face in the external radial position of which constitutes an inner cylindrical raceway or track 18, which faces the outer cylindrical raceway 10, and the faces 13 for guiding the cage 4 on the outer ring 1. On the inner ring 2, the inner, raceway 18 is defined between two axial end parts 19 of this ring 2, each having a frustoconical external surface 20 converging axially outward, and a small internal frustoconical bevel 21, at the corresponding axial end of the cylindrical internal bore 22 of the inner ring 2.

Thus, the outer ring 1 and its shoulders 11, the inner ring 2, the outer raceway 10, the inner raceway 18 and the cage 4 are coaxial about the axis X-X of the rolling bearing.

In the preferred embodiment, the rollers 3 and the outer 1 and inner 2 rings are made of a high-purity nitriding steel, deeply nitrided on all the working faces of the rollers 3 and of the rings 1 and 2 that come into contact with each other and with the cage 4. In the case of the rollers 3, these are the external faces of the cylindrical central part 5, of its frustoconical parts 6, and its lateral faces 8, and practically also of its rounded parts 7, in such a way that each roller 3 is made of a deep nitriding steel over its entire external surface. On the outer ring 1, the surfaces where the nitriding of the steel is deep are the outer raceway 10, the internal faces 12 and the cylindrical faces 13 of the shoulders 11, whereas on the inner ring 2 the only surface where the nitriding of the steel is deep is the inner raceway. 18.

The rollers 3 and the outer 1 and inner 2 rings are components that are each firstly machined from a 32CDV13 steel, produced by double vacuum smelting (the DVS process) so as to be of high purity, and preferably of the G.K.H.Y.W. grade of the French company Aubert & Duval, obtained from blanks cut from a bar of this steel for the rollers 3 and from forged blanks made of this steel for the rings 1 and 2.

The chemical composition and certain characteristics of this 32CDV13 G.K.H.Y.W. steel are indicated in the central column of the table appearing at the end of the description, and in which the coefficient K_{1c} expresses the capability of the material to contain the propagation of surface cracks.

After this operation of machining from blanks of this steel, these components (rollers 3 and rings 1 and 2) are subjected to a thermochemical deep nitriding treatment, which is a known gas nitriding treatment applied to the components for a time long enough for the nitriding to reach a depth lying within a range extending from about 0.45 mm to about 0.75 mm from the surface of the treated component.

The known thermochemical gas nitriding treatment on a finished machining component essentially consists in enclosing the component in a confined chamber, such as a furnace, in which the component is subjected to a temperature gradient and held in a nitrogen atmosphere at a controlled pressure, for a controlled exposure time in order for the nitrogen to diffuse from the surface of the steel component toward the interior of this component, up to a desired depth.

When the deep nitriding of the 32CDV13 steel is desired only at certain surfaces, as is the case on the rings 1 and 2, the other visible surfaces of a treated component are either masked during the thermochemical nitriding treatment or machined so as to have an extra thickness at these other surfaces, which are then treated by the thermochemical deep nitriding treatment and then remachined so as to remove the extra thickness in which the deep nitriding has taken place, these two methods of implementation being known.

It is known that a nitriding treatment of a steel has the consequence of forming a surface nitride layer composed essentially of nitrides Fe₄N and Fe₂N, which is white in color, and covers the nitrided layer that itself covers the core of the component. This white surface layer of abrasive nitrides is brittle and has a tendency to exfoliate during rolling, and this white surface nitride layer is completely removed by machining at least all those of the deep-nitrided faces of the rollers 3 and of the rings 1 and 2 that are working faces, that is to say those intended to come into contact with one another and/or with the cage 4. This operation is carried out so that there no longer remains any trace of the white nitriding layer on these working faces.

The rollers 3 and the rings 1 and 2 made of 32CDV13 nitriding steel have, on their deep-nitrided working faces, and in particular at the tracks or raceways, a surface Vickers hardness lying within a range extending from about 720 to about 850 under a load of 0.5 kg and a core Vickers hardness (beneath the nitrided layer) lying within a range extending from about 330 to about 420 under a load of 0.5 kg. The optimum hardness profile obtained on such deep nitriding steel components is represented by the curve 23 in FIG. 9, in which the Vickers hardness under a load of 0.5 kg is plotted on the y-axis as a function of the depth, expressed in mm from the surface, plotted on the x-axis, and this curve 23 of the hardness profile shows a steeply sloping decrease of the Vickers hardness under a load of 0.5 kg, from a value of about 825 (HV 0.5) for a depth of 0.1 mm to a value of about 400 (HV 0.5) for a depth of about 1 mm, followed by an approximately constant hardness of around 400 (HV 0.5) for a depth of 1 to 1.5 mm.

As a variant, the rollers 3 are made, as described above, of a 32CDV13 steel of G.K.H.Y.W. grade deeply nitrided (from about 0.45 to about 0.75 mm in depth) without any trace of white surface nitride layer on the working faces, but the rings 1 and 2 are made of another steel, such as an M50NIL-type structural case-hardening steel, the chemical composition and certain characteristics of which are indicated in the first column of the aforementioned table. The M50NIL steel, according to the United States Standard AMS 6278, is also produced by double vacuum smelting, in order to be of high purity, and, after the rings 1 and 2 have been machined from forged blanks of this steel, the rings 1 and 2 undergo a thermochemical case-hardening treatment, at least on their working faces (outer raceway 10 and internal faces 12 and cylindrical faces 13 of the shoulders 11 on the outer ring 1, and inner raceway 18 on the inner ring 2), these being denoted by the terms “raceway” in the table, and where the characteristics indicated in the central part of this first column of the table are obtained, whereas the core characteristics (beneath the case-hardened layer) are indicated in the lower part of this first column of the table.

According to another variant, the rollers 3 are again produced as described above, whereas the rings 1 and 2 are made of another steel, such as a conventional bearing steel of the 80DCV40 type, also called M50, according to the US Standard AMS 6491, again produced by double vacuum smelting (DVS process) in order to have excellent purity, the rings 1 and 2 produced from this steel having also undergone, after they have been machined from forged blanks, a through-hardening heat treatment that gives them, at the core as at the working faces or raceways and tracks, a Rockwell hardness of 61 to 63 HRc and a high core mechanical strength of 2800 MPa, the chemical composition of this steel and its characteristics corresponding to those given for the other two steels considered above being indicated in the third column (right-hand column) of the aforementioned table.

According to yet another variant, in which the rollers 3 are again produced as described above, the rings 1 and 2 are on the other hand made from another conventional bearing steel, of the 100C6 type, preferably also produced by the DVS process, the rings 1 and 2 being subjected to a through-hardening heat treatment after they have been machined from forged blanks made of this steel.

In all the illustrative examples, the thermochemical deep nitriding treatment, that takes place on the rollers 3 after a blank grinding operation on the rollers, is followed by a finish and superfinish grinding operation on the rollers 3.

The same applies in the case of the rings 1 and 2, after their thermochemical deep nitriding or case-hardening treatment, or else after their through-hardening heat treatment, depending on whether these rings 1 and 2 are made of 32CDV13 G.K.H.Y.W. or M50NIL or 80DCV50 (M50) as explained above.

FIG. 7 shows the profiles of the residual stresses in finished machining components (rollers and rings) before thermochemical deep nitriding or case-hardening treatment or before through-hardening heat treatment, depending on the steel used for producing the rings 1 and 2, these profile curves being shown very close to the surface.

Profile curve 24, for 32CDV13 steel, shows that, starting from a surface compressive stress of around −400 MPa, the residual compressive stresses very rapidly decrease at a depth of, between about 5 μm and 10 μm, then become approximately constant around −200 MPa at a depth varying from about 10 μm to about 20 μm and then increase with a much gentler slope before reaching about −300MPa at, a depth of around 50 μm.

Curve 25, corresponding to the profile of the residual stresses in, M50NIL steel, has a generally similar appearance, with a rapid decrease of the compressive stresses from about −500 MPa at the surface to about −150 MPa at a, depth of around 20 μm, then an increase with a much gentler slope up to a compressive stress of around −200 MPa for a depth of about 50 μm.

Curve 26, corresponding to the profile of the residual stresses in 80DCV40 or M50 steel, also shows a very rapid decrease in the residual compressive stresses from a value of about −450 MPa at the surface to a zero value for a depth of around 12 to 13 μm, the residual stresses then being tensile stresses of around 25 to 30 MPa for a depth varying from about 20 μm to about 50 μm.

In FIG. 8, curves 24′, 25′ and 26′ show the residual stress profiles corresponding to the profiles 24, 25 and 26 of FIG. 7 for the 32CDV13, M50NIL and 80DCV40 (or M50) steels respectively, but after their thermochemical deep nitriding treatment in the case of the 32CDV13 steel or their thermochemical case-hardening treatment in the case of the M50NIL steel or their through-hardening heat tratment in the case of the 80DCV40 (or M50) steel.

It may be seen on profile 24′ that, from residual compressive stresses in the nitrided 32CDV13 steel of around −200 MPa practically at the surface, the compressive stresses rapidly increase up to about −430 MPa at a depth slightly greater than 100 μm, then become approximately constant to a depth of around 400 μm, from which the residual compressive stresses decrease relatively rapidly to become zero at a depth of about, 800 μm, beyond which depth the residual stresses are approximately constant tensile stresses of low value.

In contrast, curve 25′ of the profile of the residual compressive stresses in case-hardened M50NIL steel is substantially constant around −200 MPa from a very shallow depth to a depth of about 800 μm, beyond which depth these residual compressive stresses slowly decrease.

As regards curve 26′ of the profile of the residual stresses in 80DCV40 (or M50) steel after through-hardening, this is practically coincident with the x-axis that indicates the depth beneath the surface in μm.

By comparing FIGS. 7 and 8, it is possible to state that, on the one hand, the thermochemical deep nitriding treatment essentially has the effect of shifting the strongly decreasing zone of the residual stress profile further into the depth and that, on the other hand, the profiles of the residual stresses generated during the finish and superfinish grinding operations, that follow the thermochemical deep nitriding treatment, are superimposed on the profiles obtained by the thermochemical deep nitriding effect. This results from the fact that these finish and superfinish grinding operations correspond, in FIG. 8, to a displacement of the surface, that is to say from the origin of the x-axis, by about 400 μm into the depth, and therefore along this axis.

It has been found that the lifetime of such rolling bearings with deep nitriding steel tapered cylindrical rollers 3 is doubled, compared with that of known rolling bearings of this type, before the appearance of the first surface fatigue cracks that cause spalling of the raceways and tracks of the rings 1 and 2 and of the rollers 3.

The deep nitriding steel tapered cylindrical roller bearings according to the invention exhibit better indentation behavior of the contacting surfaces during ingestion of foreign particles, and also better behavior under limiting lubrication conditions, compared with known rolling bearings of the same type.

The rolling bearings according to the invention are, for these reasons, particularly well suited for being applied to the rotary mounting of aircraft turbojet and turbine compressor rotor stages.

TABLE OF CHEMICAL COMPOSITIONS AND
CHARACTERISTICS OF THE STEELS USED

| | | 32CDV13 | 80DCV40 |
|---|---|---|---|
| | M5 0NIL | G.K.H.Y.W. | (M50) |
| Smelting | DVS | DVS | DVS |
| C (*) | 0.12 | 0.3 | 0.8 |
| Cr (*) | 4 | 3 | 4 |
| Mo (*) | 4 | 1 | 4 |
| V (*) | 1.2 | 0.2 | 1 |
| Ni (*) | 3.5 | 0.15 | 0.15 |
| US Standard AMS | 6278 | 6481 | 6491 |
| Operating | <350° C. | <300° C. | <350° C. |
| temperature | | | |

Raceway:

| | | | |
|---|---|---|---|
| Distribution: | | | |
| Carbides | Uniform | | Banded |
| Nitrides | | Uniform | |
| Grain index (size) | 7 | 8 | 8 |
| Residual austenite | <6% | ≅0 | <3% |
| Rockwell hardness | 59-62 HRc | >63 HRc | 61-63 HRc |

Core:

| | | | |
|---|---|---|---|
| Distribution: | | | |
| Carbides | | | Banded |
| Nitrides | | | |
| Grain index (size) | 8 | 8 | 8 |
| Rockwell hardness | 40 HRc | ≅40 HRc | 61-63 HRc |
| Mechanical | 1250 MPa | 1250 Mpa | 2800 MPa |
| strength Rₘ | | | |
| K_{1c} | 60 MPa · m^{½} | 100 MPa · m^{½} | 20-30 MPa · m^{½} |

(*) - in % by weight.

1. A tapered cylindrical roller bearing, the steel rollers (3) of which are held in a cage (4) between a cylindrical inner raceway (18), defined on a smooth surface in an external radial position on a steel inner ring (2), and a cylindrical outer raceway (10)., defined on a surface in an internal radial position of a steel outer ring (1) and bordered by at least one annular lateral shoulder (11) projecting substantially radially inward on the outer ring (1), which is coaxial with the inner ring (2), with the raceways (10, 18) facing each other and with said annular shoulder (11), characterized in that at least the rollers (3) are made of a deep-nitrided nitriding steel comprising, in percent by weight, around:
0.3% C,
3% Cr,
1% Mo,
0.2% V,
0.15% Ni,
produced by double vacuum smelting, and the white surface layer of nitrides of which has been completely removed from at least all the working faces (5, 6, 8) of the rollers (3) that come into contact with the rings (1, 2) and/or the cage (4).

2. The roller bearing as claimed in claim 1, characterized in that the depth of nitriding of the deep nitriding steel lies within a range extending from about 0.45 mm to about 0.75 mm.

3. The roller bearing as claimed in either of claims 1 and 2, characterized in that the deep-nitrided nitriding steel is a 32CDV13 steel.

4. The roller bearing as claimed in claim 3, characterized in that the 32CDV13 steel is of the G.K.H.Y.W. grade of the French steelmaker Aubert & Duval.

5. The roller bearing as claimed in any one of claims 1 to 4, characterized in that at least one of the outer (1) and inner (2) rings is made of a conventional bearing steel of the 100C6 type.

6. The roller bearing as claimed in any one, of claims 1 to 5, characterized in that; at least one of the outer (1) and inner (2) rings is made of a conventional bearing steel of the M50 (or 80DCV40) type comprising, in percent by weight, around:
0.8% C,
4% Cr,
4% Mo,
1% V,
0.15% Ni,
and produced by double vacuum smelting and with a through-hardening heat treatment.

7. The roller bearing as claimed in any one of claims 1 to 6, characterized in that at least one of the outer (1) and inner (2) rings is made of a structural case-hardening steel of the M50NIL type comprising, in percent by weight, around:
0.12% C,
4% Cr,
4% Mo,
1.2% V,
3.5% Ni,
and produced by double vacuum smelting and with a thermochemical case-hardening treatment.

8. The roller bearing as claimed in any one of claims 1 to 7, characterized in that at least one of the outer (1) and inner (2) rings is made of a nitriding steel similar or identical to that of the rollers (3) and deeply nitrided with complete removal of the white surface layer of nitrides over at least the entire surface (10, 12, 13; 18) of said ring (1, 2) that is intended to come into contact with the rollers (3) and/or the cage (4).

9. The roller bearing as claimed in any one of claims 1 to 8, characterized in that the rollers (3) and, where appropriate, the ring or rings (1, 2) made of deep nitriding steel have a surface Vickers hardness lying within a range extending from about 720 to about 850 under a load of 0.5 kg and a core Vickers hardness lying within a range extending from about 330 to about 420 under a load of 0.5 kg.

10. The roller bearing as claimed in any one of claims 1 to 9, characterized in that the cage (4) is a one-piece metal cage, with as many cells as there are rollers (3), each cell housing one of the rollers (3) respectively, said cage (4) being centered on the outer ring (1).

11. The roller bearing as claimed in claim 10, characterized in that the metal cage (4) is made of bronze or of a vacuum-smelted 40NCD7-type steel, with surface silvering at least in the cells.

12. The roller bearing as claimed in any one of claims 1 to 11, characterized in that the cylindrical outer raceway (10) is defined on the outer ring (1) between two annular lateral shoulders (11) projecting substantially radially inward.

13. The roller bearing as claimed in any one of claims 1 to 12, characterized in that each shoulder (11) has an internal face (12), turned toward the rollers (3), that has a small taper angle lying within a range extending from about 15′ to about 45′.

14. The roller bearing as claimed in any one of claims 1 to 13, characterized in that each shoulder (11) has a cylindrical surface (13), in an internal radial position, coaxial with the outer raceway (10) and forming a surface for centering the cage (4).

15. The roller bearing as claimed in any one of claims 1 to 14, characterized in that the ratio of, the radial height of each shoulder (11), to the diameter of the rollers (3) lies within a range extending from about 0.29 to about 0.31.

16. The roller bearing as claimed in any one of claims 1 to 15, characterized in that the inner raceway (18) is defined on the inner ring (2) between two axial end portions (19) of said inner ring (2), each having a frustoconical external face (20) converging axially outward.
